(19) United States
(12) Patent Application Publication
(10) Pub. No.: US 2014/0126447 A1
(43) Pub. Date: May 8, 2014

(54) Voice Group Call Service Over Multimedia Broadcast Multimedia Services Bearers

(71) Applicants: Henri Markus Koskinen, Espoo (FI); Johanna Katariina Pekonen, Espoo (FI)

(72) Inventors: Henri Markus Koskinen, Espoo (FI); Johanna Katariina Pekonen, Espoo (FI)

(73) Assignee: Nokia Solutions and Networks Oy, Espoo (FI)

(21) Appl. No.: 14/125,118

(22) PCT Filed: Jun. 10, 2011
(86) PCT No.: PCT/EP2011/059743

§ 371 Date: Dec. 10, 2013

(51) Int. Cl. H04L 12/18

(52) U.S. Cl. CPC H04L 12/189
USPC 370/311

(57) ABSTRACT

The invention relates to an apparatus including: at least one processor and at least one memory including a computer program code, the at least one memory and the computer program code configured to, with the at least one processor, cause the apparatus at least to: convey group-service-specifically group-service data targeted to at least one group of devices by using at least one broadcast-service bearer, and indicate the at least one broadcast-service bearer being active for group-service data conveyance even when the group-service data is not conveyed.

### FIELD

The invention relates to apparatuses, methods, a system, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

As an evolution of the current international wireless communications standard for railway communication and applications, known also as the Global System for Mobile Communications (GSM)-Railway system, a future solution based on the Long Term Evolution (LTE) is currently developed. This evolved system is referred to as Long Term Evolution (LTE) Railway (R).

It is targeted to provide means for voice and data communication between railway operational staff, such as drivers, traffic controllers and engineers. It is designed to support a plurality of services, such as a voice group call service (VGCS) and call pre-emption in case of an emergency. It is designed to support cargo tracking, video surveillance in trains and at stations, and passenger information services, etc.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: convey group-service-specifically group-service data targeted to at least one group of devices by using at least one broadcast-service bearer, and indicate the at least one broadcast-service bearer being active for group-service data conveyance even when the group-service data is not conveyed.

According to yet another aspect of the present invention, there is provided an apparatus comprising: at least one processor and at least one memory including a computer program code, the at least one memory and the computer program code configured to, with the at least one processor, cause the apparatus at least to: check group-service scheduling information, and if the service scheduling information indicates existence of group-service data in a multicast channel scheduling period, listen to the group-service data, and indicate to a higher application layer active status of the group-service.

According to yet another aspect of the present invention, there is provided a method comprising: conveying group-service-specifically group-service data targeted to at least one group of devices by using at least one broadcast-service bearer, and indicating the at least one broadcast-service bearer being active for group-service data conveyance even when the group-service data is not conveyed.

According to yet another aspect of the present invention, there is provided a method comprising: checking group-service scheduling information, and if the service scheduling information indicates existence of group-service data in a multicast channel scheduling period, listening to the group-service data, and indicating to a higher application layer active status of the group-service.

According to yet another aspect of the present invention, there is provided an apparatus comprising: means for conveying group-service-specifically group-service data targeted to at least one group of devices by using at least one broadcast-service bearer, and means for indicating the at least one broadcast-service bearer being active for group-service data conveyance even when the group-service data is not conveyed.

According to yet another aspect of the present invention, there is provided an apparatus comprising: means for checking group-service scheduling information, and means for listening to the group-service data and means for indicating to a higher application layer active status of the group-service in the case the service scheduling information indicates existence of group service data in a multicast channel scheduling period.

According to yet another aspect of the present invention, there is provided a computer program embodied on a computer-readable storage medium, the computer program comprising program code for controlling a process to execute a process, the process comprising: conveying group-service-specifically group-service data targeted to at least one group of devices by using at least one broadcast-service bearer, and indicating the at least one broadcast-service bearer being active for group-service data conveyance even when the group-service data is not conveyed.

According to yet another aspect of the present invention, there is provided a computer program embodied on a computer-readable storage medium, the computer program comprising program code for controlling a process to execute a process, the process comprising: checking group-service scheduling information, and if the service scheduling information indicates existence of group-service data, listening to the group-service data in a multicast channel scheduling period, and indicating to a higher application layer active status of the group-service.

### LIST OF DRAWINGS

Some embodiments of the present invention are described below, by way of example only, with reference to the accompanying drawings, in which

FIG. 1 illustrates an example of a system;

FIG. 2 is a flow chart

FIG. 3 illustrates examples of apparatuses,

FIG. 4 is another flow chart, and

FIG. 5 illustrates other examples of apparatuses.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. For example, the embodiments are applicable to both frequency division duplex (FDD) and time division duplex (TDD).

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

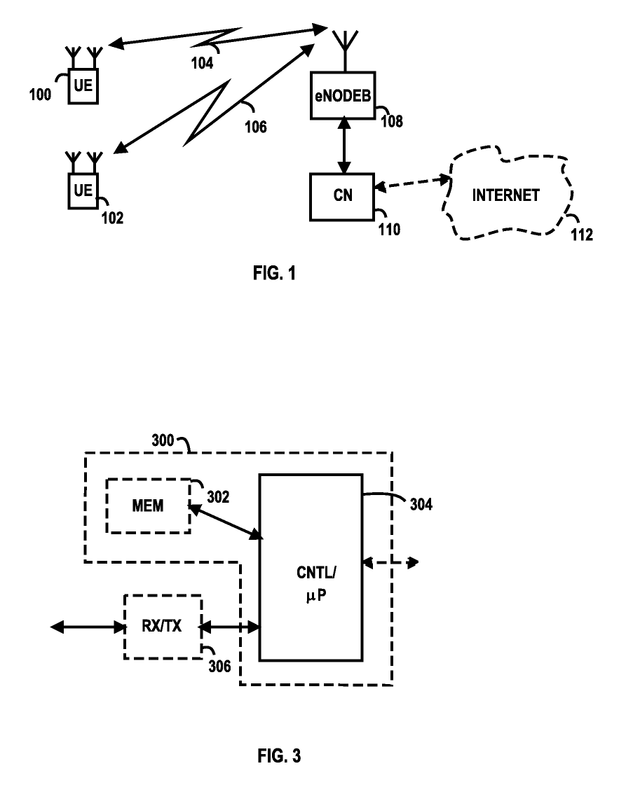

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with the necessary properties. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS).

FIG. 1 shows a part of a radio access network of E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or evolved node B (eNodeB, eNB) in LTE and in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1 may provide any kind of these cells. A cellular radio system may be implemented as a multilayer network including several kinds of cells. In multilayer networks, typically, one (e)Node B provides one kind of a cell or cells, and thus a plurality of (e)Node Bs are required to provide such a network structure.

As an evolution of the current international wireless communications standard for railway communication and applications, known also as the Global System for Mobile Communications (GSM)-Railway system, a future solution based on the Long Term Evolution (LTE) is currently developed. This evolved system is referred to as Long Term Evolution (LTE) Railway (R).

It is targeted to provide means for voice and data communication between railway operational staff, such as drivers, traffic controllers and engineers. It will support a plurality of services, such as a voice group call service (VGCS) and call pre-emption in case of an emergency. It is designed to support cargo tracking, video surveillance in trains and at stations, and passenger information services, etc.

It is assumed that the LTE-R will be implemented using dedicated eNode Bs close to a railway. The users of LTE-R may be located in trains, stations, depots, on the field, controlling centres, hubs, etc.

Voice group call service (VGCS) is designed to provide a single voice call on one or more channels in order that it can be simultaneously received by a predefined group of service subscribers. Group calls may be limited to a specific geographic area. Simultaneous voice group calls may exist for different groups in the same group call area.

In the VGCS users may have one of the following statuses: a talker, listener and dispatcher. Information on group members, including identification, assigned priorities, and capabilities, is typically stored in a group call register (GCR).

VGCS may operate in a half-duplex (one-way at a time) communication mode. Hence, a push-to-talk function may be utilized. A push to talk (PTT) process involves a user wishing to talk pressing a talk button before transmission.

Multimedia Broadcast and Multicast Services (MBMS) is a broadcasting service which may be provided by the LTE. MBMS uses broadcast distribution for conveying data from a single source to multiple targets. MBMS architecture usually includes a broadcast/multicast service centre (BM-SC) which controls the service. It is typically located in the core network. LTE-MBMS may be called evolved MBMS or eMBMS.

In the LTE specifications, the discovery chain for a user device to be informed on a starting MBMS-service session (and hence potentially also a group-call indication), is as follows: the user device monitors periodically for an MBMS control channel (MCCH) change notification that is a specific packet data control channel (PDCCH) message identified by a multicast radio network temporary identifier (M-RNTI). Such a notification identifies which of the possible 8 MCCHs in a cell is going to have modified contents. At the start of the next modification period of that MCCH, the user device receives the identified MCCH, (MCCH content may not change within a modification period). Then, the user device identifies the service at issue from the MCCH content, and finds the necessary transmission parameters in order to start receiving the service.

As currently captured in Specification TS 36.331, current value ranges of the various MBMS-specific parameters cater quite poorly for delay requirements of VGCS: the MCCH modification period is currently at least 5 seconds, which has a significant impact to the achievable call setup time, and the MCCH scheduling period is at least 80 ms, which, in the light of the normal eNodeB operation, may increase an end-to-end packet delay in achieving sufficient voice-service quality experience.

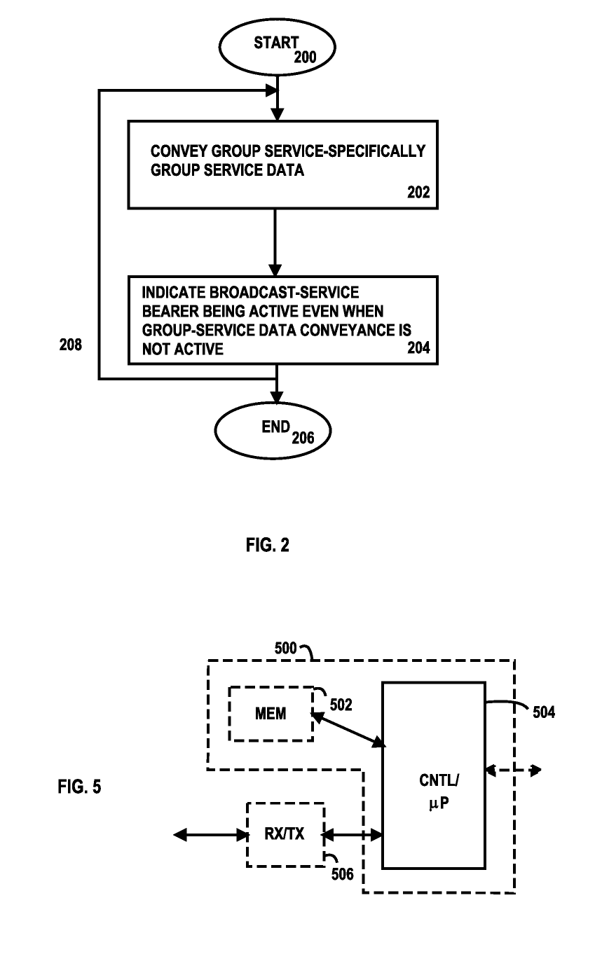

In the following, some embodiments are disclosed in further details in relation to FIG. 2. The embodiment of FIG. 2 is usually related to a server, node, base station or host. The embodiment begins in block 200.

In block 202, group-service data targeted to at least one group of devices is conveyed group-service-specifically by using at least one broadcast-service bearer

A broadcast-service bearer may be a radio bearer designed for being used in broadcasting (in general, a bearer may carry one or more services). As already explained above, broadcasting is typically used for conveying at the same time same data to multiple users. The MBMS-service of the LTE is one example of a broadcast service.

A group-service may be a voice group call service (VGCS) designed to provide a single voice call on one or more channels in order that it can be simultaneously received by a predefined group of service subscribers. Group calls may be limited to a specific geographic area. Simultaneous voice group calls may exist for different groups in the same group call area.

Group-service data may be a call, a video call, video clip, etc.

A target device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. The target device may also be designed for a LTE-Railway system.

In block 204, at least one broadcast-service bearer is indicated being active for group-service data conveyance even when the group-service data is not conveyed.

At least one “continuous” bearer may be provided. The bearer is continuous typically in the sense that the information that the at least one broadcast-service bearer is active (conveying data) for service data transmission is signaled even when the service data transmission is not actually active (not conveying data). In this case, a node may signal once in a multicast channel scheduling period the location of service data in the period. When the service in question is not active, no data is conveyed on its bearer, which may also be informed in scheduling data. This enables more reasonable usage of user devices' batteries: when services are multiplexed on a same multicast channel and transmitted, the period of time when every service occurs in a radio transmission is smaller than the period of time when scheduling data is transmitted. It should be appreciated that Voice over Internet (VoIP) packets are usually conveyed every 20 ms whereas it is preferred that a user device does not wake up to check scheduling data more often than every second. When service data is conveyed, scheduling data may inform a user device that the service is “on”, and thus that the user device has to be in a reception mode, for the whole duration of the scheduling period, even when it is not true. This enables more economical usage of user device's battery.

According to the current LTE specifications, MBMS-service broadcast (and its reception by a user device) is divided into multicast channel (MCH) scheduling periods (MSP, the duration of which is configurable). Typically, for each such a period, a node B (or eNodeB) receives from a core network service data from each service to be time division multiplexed on that multicast channel to be broadcast in that period as indicated by synchronization (SYNC) protocol headers. The (e)Node B also forms MCH scheduling information (MSI) medium access control (MAC) control element indicating the last subframe in that period carrying each service, and broadcasts first the MSI and then the time division multiplexed services one after another in a predetermined order using subframes of that MCH for that period.

It should be understood that in the procedure above, the service data must be received in its entirety in order that all (e)Node Bs involved are able to produce identical MSIs, which has its implications on end-to-end packet delays.

In an embodiment, a (e)Node B does not wait until having received all service data for a given scheduling period before conveying the service data, but instead, conveys data in a given scheduling period already while receiving the rest of service data for that scheduling period. Hence, SYNC timestamping may be carried out by a broadcast/multicast service centre (BM-SC) adhering to delay requirements of voice over Internet protocol (VoIP) service. Hence, the service data may be conveyed according as multicast channel scheduling periods are available.

It should be appreciated that the procedure described above typically assumes that, for the multicast traffic channel (MTCH) of each service, only two allowed values for the “Stop MTCH” field in the MCH scheduling information MAC control element [TS 36.321] are provided: first, a (already specified) special value 2047 indicating that the service is not scheduled in that period, and second, a value implying that the service is scheduled throughout the whole period (even if not the case, such as e.g. at the end of a call). For the start of each scheduling period, a (e)Node B may apply a time limit to determining whether a given service seems to be scheduled in that period, and acts accordingly.

SYNC timestamping may apply a 20 ms increment (assuming voice over Internet protocol (VoIP) packets being generated and received every 20 ms), and based on this timestamping, a (e)Node B may apply MAC-multiplexing of service data for each simultaneously active call separately in each MCH subframe, instead of in each scheduling periods in the current LTE specifications. The SYNC timestamping may vary according to current needs and/or standards. The service data may be multiplexed or MAC-multiplexed for each service in each multicast channel subframe.

Resource allocation for a multicast channel may be according to a VoIP packet conveyance or other standard.

The duration of each multicast channel (MCH) scheduling period may be set to an at least substantially large value. For instance, the MCH scheduling period may be set to 1.28 seconds corresponding a typical paging discontinuous reception (DRX) period.

In one embodiment, if group-service data conveyance is active, the existence of service data throughout the duration of the multicast channel scheduling period is signaled in scheduling information.

It should be appreciated, that embodiments do not necessarily have impact on the operation of a user device. The user device may keep receiving always-on MBMS broadcast bearers corresponding to a group identity (ID) it has subscribed to. Upon discovering actual data for a given group identity, the user device may simply deliver the data to higher layers which may function as implicitly alerting the application of an incoming call.

To explain one embodiment in a simplified manner, to cater for a call-setup time and end-to-end delay requirements of a group telephony service, it may be said that a current operation model of LTE MBMS is modified on two accounts, first, with regard to the start of each service session (corresponding to a call) going through a session start procedure causing a significant delay, and second, on the part, wherein during service data conveyance, the two time periods, when a user device wakes up to check for service scheduling, and the duration of the period of time a (e)Node B must receive service data from a core network before radio transmissions are equal.

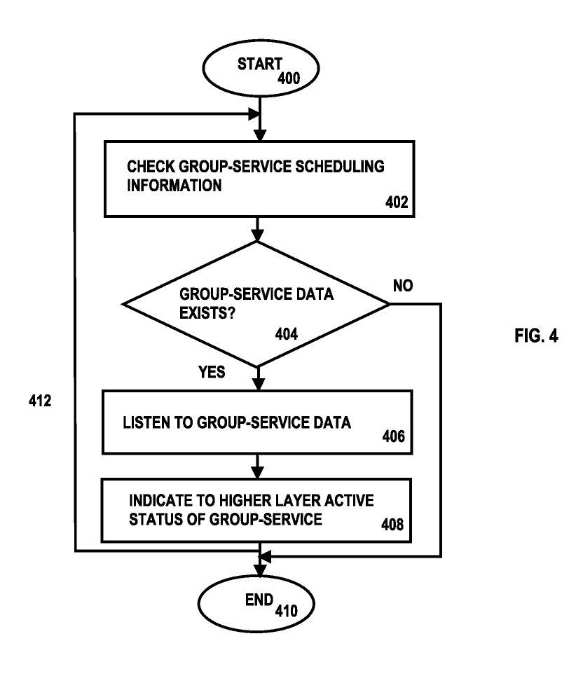

An embodiment of a method carried out in a user device supporting or counter-parting above disclosed embodiments, are now explained shortly by means of FIG. 4. The embodiment begins in block 400.

In block 402, group-service scheduling information is checked.

The group-service may be a voice group call service (VGCS) designed to provide a single voice call on one or more channels in order that it can be simultaneously received by a predefined group of service subscribers. Group calls may be limited to a specific geographic area. Simultaneous voice group calls may exist for different groups in the same group call area.

Group-service data may be a call, video call, video clip, etc.

The checking may be carried out once in a scheduling period of the multicast channel.

If (block 404) the group-service scheduling information indicates the existence of group-service data in a multicast channel scheduling period, the group-service data is listened to (block 406) and a higher application layer is indicated of the group-service being active (block 408).

In an embodiment, the user device interprets that the service is “on” only when a broadcast bearer carries data. This may be on the responsibility of the application layer which is above the radio-protocol stack according to the open systems interconnection model (OSI model). On the other hand, the system may support a “continuous” bearer procedure described above.

The embodiment ends in block 410. The embodiment is repeatable in many ways. One example is shown by arrow 412 in FIG. 4.

As to applicability to the LTE-Railway, it should be noted that in terms of concurrently active group calls per a multicast channel, railway operators have now access to 4 MHz of frequency spectrum, and thus it can be estimated that a single MCH subframe (and hence a MCH) of 4 MHz is typically able to accommodate roughly ten 50-byte VoIP packets of simultaneous calls. Thus, a need to configure more than one MCH exists. Additionally, if different group-call areas need to be configured in the network, multi-media broadcast over single frequency networks (MBSFNs) with different sets of participating cells typically require their own multicast channels.

The embodiment ends in block 206. The embodiment is repeatable in many ways. One example is shown by arrow 208 in FIG. 2.

The steps/points, signaling messages and related functions described above in FIG. 2 or 4 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting and/or receiving may herein mean preparing a data conveyance, transmission and/or reception, preparing a message to be conveyed, transmitted and/or received, or physical transmission and/or reception itself, etc. on a case by case basis.

An embodiment provides an apparatus which may be any node, host, server or any other suitable apparatus capable to carry out processes described above in relation to FIG. 2.

FIG. 3 illustrates a simplified block diagram of such an embodiment.

As an example of an apparatus according to an embodiment, it is shown an apparatus 300, such as a node device, host or server, including facilities in a control unit 304 (including one or more processors, for example) to carry out functions of embodiments, such as indicating at least one broadcast-service bearer being active for group-service data conveyance even when the group-service data conveyance is not active.

Block 306 includes parts/units/modules need for reception and transmission, usually called a radio front end, RF-parts, radio parts, etc.

Another example of an apparatus 300 may include at least one processor 304 and at least one memory 302 including a computer program code, the at least one memory and the computer program code configured to, with the at least one processor, cause the apparatus at least to: convey group-service-specifically group-service data targeted to at least one group of devices by using at least one broadcast-service bearer, and indicate the at least one broadcast-service bearer being active for group-service data conveyance even when the group-service data is not conveyed.

Yet another example of an apparatus comprises means 304 for conveying group-service-specifically group-service data targeted to at least one group of devices by using at least one broadcast-service bearer, and means 304 for indicating the at least one broadcast-service bearer being active for group-service data conveyance even when the group-service data is not conveyed.

Yet another example of an apparatus comprises a conveying unit configured to convey group-service-specifically group-service data targeted to at least one group of devices by using at least one broadcast-service bearer, and an indicator configured to indicate the at least one broadcast-service bearer being active for group-service data conveyance even when the group-service data is not conveyed.

Another embodiment provides an apparatus which may be any user device or any other suitable apparatus capable to carry out processes described above in relation to FIG. 4.

FIG. 5 illustrates a simplified block diagram of such an apparatus. As an example of an apparatus according to an embodiment, it is shown an apparatus 500, such as a user device, including facilities in a control unit 504 (including one or more processors, for example) to carry out functions of embodiments, such as checking group-service scheduling information, listening to group-service data and indicating to a higher application layer active status of the group-service, if the group-service scheduling information indicates the existence of the group-service data in a multicast channel period.

Block 506 includes parts/units/modules need for reception and transmission, usually called a radio front end, RF-parts, radio parts, etc.

Another example of an apparatus 500 may include at least one processor 504 and at least one memory 502 including a computer program code, the at least one memory and the computer program code configured to, with the at least one processor, cause the apparatus at least to: check group-service scheduling information, listen to group-service data and indicate to a higher application layer active status of the group-service, if the group-service scheduling information indicates the existence of the group-service data in a multicast channel scheduling period.

Yet another example of an apparatus comprises means 504 for checking group-service scheduling information, means 504 for listening to group-service data, and means 504 for indicating to a higher application layer active status of the group-service, if the group-service scheduling information indicates the existence of the group-service data in a multicast channel scheduling period.

Yet another example of an apparatus comprises a checking unit configured to check group-service scheduling information, a communicator configured to listen to group-service data and an indicating unit configured to indicate to a higher application layer active status of the group-service, if the group-service scheduling information indicates the existence of the group-service data in a multicast channel scheduling period.

It should be understood that the apparatuses may include or be coupled to other units or modules etc, such as radio parts or radio heads, used in or for transmission and/or reception. This is depicted in FIGS. 3 and 5 as optional blocks 306 and 506.

Although the apparatuses have been depicted as one entity in FIGS. 3 and 5, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semi-conductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above.

Other embodiments provide computer programs embodied on a computer readable medium, configured to control a processor to perform embodiments of the methods described above. The computer readable medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers. The computer readable medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, digitally enhanced circuits, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
convey group-service-specifically group-service data targeted to at least one group of devices by using at least one broadcast-service bearer, and
indicate the at least one broadcast-service bearer being active for group-service data conveyance even when the group-service data is not conveyed.

2. The apparatus of claim 1, wherein the group-service data is conveyed in a Long Term Evolution (LTE) Railway system.

3. The apparatus of claim 1, wherein the at least one broadcast-service bearer is at least one Multimedia Broadcast Multicast Service (MBMS) bearer.

4. The apparatus of claim 1, wherein the group-service is carried out according to voice group call service (VGCS) procedure.

5. The apparatus of claim 1, further being caused to:
multiplex the group-service data for each service in each multicast channel subframe.

6. (canceled)

7. The apparatus of claim 1, further being caused to:
convey the group-service data according as multicast channel scheduling periods are available.

8. The apparatus of claim 1, further being caused to:
signal in scheduling information the existence of the group-service data throughout the duration of a multicast channel scheduling period, if the group-service data is conveyed.

9. The apparatus of claim 1, the apparatus comprising a server, host or node.

10. (canceled)

11. An apparatus comprising:
at least one processor and at least one memory including a computer program code, the at least one memory and the computer program code configured to, with the at least one processor, cause the apparatus at least to:
check group-service scheduling information, and
if the service scheduling information indicates existence of group-service data in a multicast channel scheduling period,
listen to the group-service data, and
indicate to a higher application layer active status of the group-service.

12. The apparatus of claim 11, wherein the group-service data is conveyed in a Long Term Evolution (LTE) Railway system.

13. The apparatus of claim 11, wherein the group-service is carried out according to voice group call service (VGCS) procedure.

14. The apparatus of claim 11, the apparatus comprising a user device.

15. (canceled)

16. A method comprising:
conveying group-service-specifically group-service data targeted to at least one group of devices by using at least one broadcast-service bearer, and
indicating the at least one broadcast-service bearer being active for group-service data conveyance even when the group-service data is not conveyed.

17. The method of claim 16, wherein the indicating of at least one broadcast-service bearer being active for the group-service data conveyance is carried out in a Long Term Evolution (LTE) Railway system.

18. The method of claim 16, wherein the at least one broadcast-service bearer is at least one Multimedia Broadcast Multicast Service (MBMS) bearer.

19. The method of claim 16, wherein the group-service is carried out according to voice group call service (VGCS) procedure.

20. The apparatus of claim 16, further comprising:
multiplexing the group-service data for each service in each multicast channel subframe.

21. (canceled)

22. The method of claim 16, further comprising:
conveying the group-service data according as multicast channel scheduling periods are available.

23. The method of claim 16, further comprising:
signalling in scheduling information the existence of service data throughout the duration of a multicast channel scheduling period, if the group-service data is conveyed.

24. (canceled)

25. A method comprising:
checking group-service scheduling information, and
if the service scheduling information indicates existence of group-service data in a multicast channel scheduling period,
listening to the group-service data, and
indicating to a higher application layer active status of the group-service.

26. The method of claim 25, wherein the group-service data is conveyed in a Long Term Evolution (LTE) Railway system.

27. The method of claim 25, wherein the group-service is carried out according to voice group call service (VGCS) procedure.

28-38. (canceled)

39. The apparatus of claim 1, further being caused to:
multiplex the group-service data for each service in each multicast channel subframe, wherein the multiplexing is carried out on a Medium Access Control (MAC) layer.

40. The method of claim 16, further comprising:
multiplexing the group-service data for each service in each multicast channel subframe, wherein the multiplexing is carried out on a Medium Access Control (MAC) layer.
